(19) United States
(12) Patent Application Publication
(10) Pub. No.: US 2007/0016367 A1
(43) Pub. Date: Jan. 18, 2007

(54) Navigation device, method for route guidance, and program

(75) Inventors: Naohiro Sakashita, Obu-city (JP); Masanori Ohmi, Gifu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/199,227

(22) Filed: Aug. 9, 2005

(30) Foreign Application Priority Data
Aug. 18, 2004 (JP) 2004-238641

(51) Int. Cl. G01C 21/32

(52) U.S. Cl. 701/211; 340/995.2

(57) ABSTRACT

A car navigation device sequentially selects one of the non-guidance intersections along the navigational route to the destination, and decides whether there is LXD data which show permitted directions to leave the intersection on entering it from each entrance lane in the entrance road. If the LXD data exist, then if there is a plurality of A-entrance lanes which is permitted to leave the intersection along roughly the same direction as the exit road goes, and if there is a plurality of roads along which at least one of the those A-entrance lanes is permitted to leave the intersection, then the car navigation device 1 determines the selected intersection to be a lane guidance intersection and executes the process for the lane guidance at the intersection.

### CROSS REFERENCE TO RELATED APPLICATION

This application is based on and incorporates herein by reference Japanese Patent Application No. 2004-238641 filed on Aug. 18, 2004.

### BACKGROUND OF THE INVENTION

1. Field of the Invention

The present invention relates to a navigation device that reduces the possibility to let a driver drive his automobile into a wrong road despite a navigational route.

2. Description of Related Art

Among navigation devices that execute route guidance to a designated destination along a navigational route, there are ones that execute lane guidance which indicates a lane to take in approaching an intersection along the navigational route. Such navigation devices are disclosed in, for example, Unexamined Japanese Patent Publication No. 2000-137894, No. 2000-251197 (corresponding to U.S. Pat. No. 6,269,3034B1), No. 2002-257571, and No. 2003-240581

However, a navigation device that executes the lane guidance in a conventional manner sometimes does not execute the lane guidance even when it is needed. Below are exemplary cases in which the situation occurs.

Firstly, FIG. 1 shows an overhead view of an intersection 51 and roads 52-56 that are connected with the intersection 51. The road 52 has five lanes that head toward the intersection 51. The ordinary road 55 only has two lanes that head away from the intersection 51. The road 56 with only two lanes heads toward almost the same direction as the road 55 does and is connected with an entrance of a highway. Suppose that a navigation device installed in an automobile calculates a navigational route, which proceeds into the intersection 51 from the road 52 (hereafter entrance road 52) and leaves the intersection 51 along the road 55.

Each lane of the entrance road 52 has a sign 61-65 painted on its surface. Each sign 61-65 indicates at least one direction along which an automobile is permitted to exit the intersection 51 when it enters the intersection 51 from the corresponding lane. The signs on the entrance lanes indicate that an automobile is permitted to exit the intersection 51 in a straight line except the one on the rightmost lane.

The navigational route mentioned above goes through the intersection 51 in a straight line. Since the route goes intuitively following the roads' structures at the intersection 51, the conventional navigation device does not magnify a map of the intersection 51 displaying on its monitor or give route guidance of the intersection 51 by voice. However, both the ordinary road 55 and the road 56 (hereafter highway entrance road 56) correspond to the sign that indicates going in a straight line, while the two leftmost lanes are connected with the ordinary road 55 and the third and the fourth lane from the left are connected with the highway entrance road 56 in the straight line. Therefore, if the navigation device does not execute the lane guidance before entering the intersection 51 in the above case, a driver possibly drives the automobile from the third or the fourth lane into the road 56 and eventually the automobile enters the highway despite the navigational route.

Secondly, FIG. 2 shows an overhead view of a bifurcation 71 as a kind of intersection, a road 72 connected with the bifurcation 71, a surface road 73, and an underground road 74. The road 72 only has two lanes that head toward the bifurcation 71. The surface road 73 only has a single lane that heads away from the bifurcation 71. The underground road 74 only has a single lane and heads toward almost the same direction as the surface road 73 does. Suppose that the navigation device calculates a navigational route, which proceeds into the bifurcation 71 from the entrance road 72 and leave the bifurcation 71 along the road 73.

The navigational route goes through the bifurcation 71 in a straight line. Since the route goes intuitively following the roads' structures at the intersection 71, the conventional navigation device does not magnify a map of the bifurcation 71 displaying on its monitor or give route guidance of the bifurcation 71 by voice. However, if the navigation device does not execute lane guidance before entering the bifurcation 71 in the case, the driver possibly drives the automobile from the rightmost lane of the entrance road 72 into the bifurcation 71 and eventually the automobile enters the underground road 74 despite the navigational route.

As described above, in a case where two roads head away from an intersection toward almost the same direction and one of the two roads is a navigational route, if a navigation device on an automobile does not execute lane guidance before the intersection, a driver possibly take a wrong entrance lane of the entrance road and eventually the automobile enters the wrong road despite the navigational route.

### SUMMARY OF THE INVENTION

The present invention addresses the above point. Thus, it is an objective of the present invention to provide a navigation device, a method for route guidance, and a program for route guidance which, in a case two roads head away from an intersection toward almost the same direction and one of the two roads is a navigational route, reduce the possibility to let a driver drive his automobile into the wrong road despite the navigational route.

To achieve the objective of the present invention, there is provided a navigation device which selects an intersection within a navigational route to a destination, decides that an entrance road into the selected intersection has a plurality of entrance lanes that meet conditions. The conditions are (1) that they have resemblance to each other in their exit directions from the selected intersection, (2) that they are connected with different roads through the selected intersection, and (3) that one of the roads is an exit road which leaves the selected intersection along the navigational route. Based on the decision, the navigation device executes a process for intensive guidance regarding the selected intersection.

Suppose a road has entrance lanes which have resemblance to each other in their exit directions from the selected intersection and which are connected with different roads through the selected intersection as well. In this case, it is highly likely for a driver to misunderstand that he can leave the intersection along any of these different roads by going along any of these entering lanes. So if the roads connected with such entrance lanes include the exit road which leaves the selected intersection along the navigational route, the driver possibly drive an automobile into the intersection from a wrong entering lane not connected with the exit road.

The navigation device of the present invention decides that the entering road into the selected intersection has such a plurality of entering lanes, and executes a process for intensive guidance regarding the selected intersection based on the decision. Therefore, the driver becomes able to pay a special attention to the selected intersection. Thus, the navigation device reduces the possibility than ever to let the driver drive the automobile into the wrong road despite the navigational route.

To achieve the objective of the present invention, there is also provided a method for route guidance, selecting an intersection within a navigational route to a destination, deciding that an entrance road into the selected intersection has a plurality of entrance lanes that meet the above conditions, and based on the decision executing a process for intensive guidance regarding the selected intersection.

To achieve the objective of the present invention, there is also provided a computer program product for route guidance comprising at least one computer-readable medium and a computer program mechanism embedded in the medium. The program causes a computer to, select an intersection within a navigational route to a destination; to decide that an entrance road into the selected intersection has a plurality of entrance lanes that meet the above conditions, and based on the decision to execute a process for intensive guidance regarding the selected intersection.

### BRIEF DESCRIPTION OF THE DRAWINGS

The invention, together with additional objective, features and advantages thereof, will be best understood from the following description, the appended claims and the accompanying drawings in which:

FIG. 1 is an overhead view of an intersection and roads connected with the intersection;

FIG. 2 is an overhead view of a bifurcation and roads connected with the bifurcation;

FIG. 3 is a hardware block diagram of a car navigation device according to a first embodiment of the present invention; and

FIG. 4 is a flowchart of a program that a controlling circuit runs.

### DETAILED DESCRIPTION OF THE INVENTION

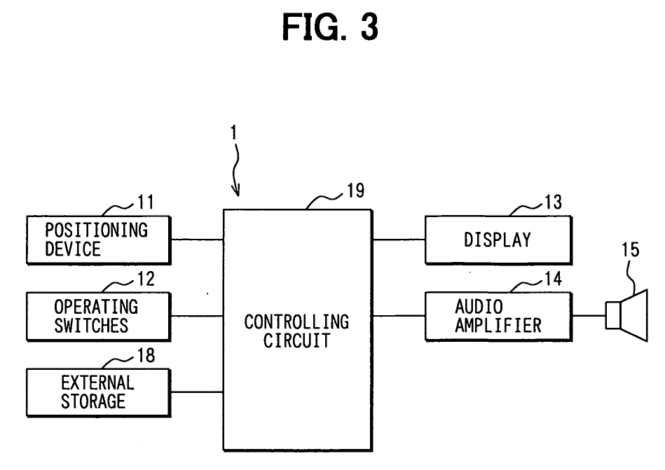

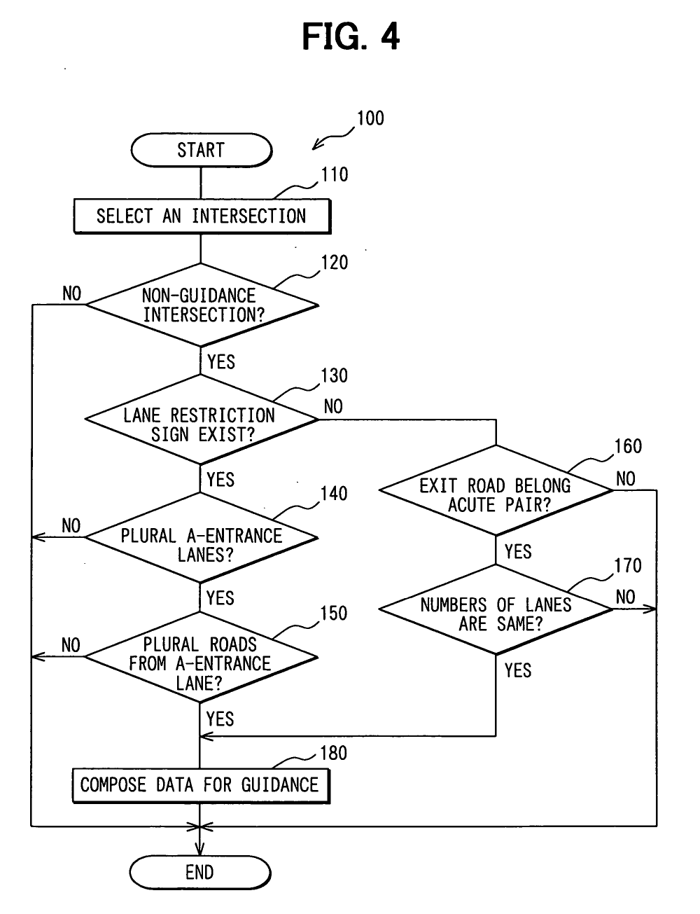

A first embodiment of the present invention will be described below. FIG. 3 shows a hardware block diagram of a car navigation device 1 according to the present embodiment.

The car navigation device 1 includes a positioning device 11, operating switches 12, a display 13, an audio amplifier 14, a speaker 15, an external storage 18, and a controlling circuit 19.

The positioning device 11 has sensors such as a geomagnetic sensor, a gyroscope, a vehicle speed sensor, and a GPS receiver, and outputs information characterized by the sensors for specifying current position and/or direction of the vehicle.

The operating switches 12 include input devices such as mechanical switches attached to the surface of the car navigation device 1 and a touch panel overlaid on a screen of the display 13. Additionally, the operating switches 12 output signals to the controlling circuit 19 based on holding down of the mechanical switches and touching the touch panel by a driver.

The display 13 displays images based on video signals from the controlling circuit 19. The images to display are, for example, maps around current position.

The audio amplifier 14 amplifies audio signals from the controlling circuit 19 and outputs the resultant signals to the speaker 15.

The external storage 18 is a nonvolatile storage medium such as an HDD. It stores programs which the controlling circuit 19 retrieves and runs and map data for route guidance.

The map data include information about location of roads and intersections, about how they are connected with each other, about the configuration of each of the roads, and about the number of lanes each of the roads has, and also include lane-classified exit direction data regarding each of the roads. In the map data, each of the routes is represented by a link and each of the intersections is represented by a node.

The lane-classified exit direction data (hereafter LXD data) are represented by a table that has entry lines, each corresponding to a lane proceeding into an intersection connected with the corresponding road. Each entry line has a direction flag, showing a direction (or directions) along which it is permitted to exit the intersection on entering it from the corresponding lane. The direction flag has bits of ON or OFF, each corresponding to one of directions (ex. forward, forward right, right, backward right, backward, backward left, left, forward left). The value ON means that the corresponding lane permits to exit the intersection along the corresponding direction. Thus, LXD data show which direction each lane in the corresponding road permits to exit the intersection along.

The LXD data are made based on lane restriction signs such as signs painted on roads and signs by the roads, which indicate lane-classified directions along which an automobile is permitted to exit intersections. Therefore, if there is no such sign around a road that proceeds into an intersection, the LXD data corresponding to the road has void data. For example, in such occasion, the direction flags of the LXD data have bits of OFF.

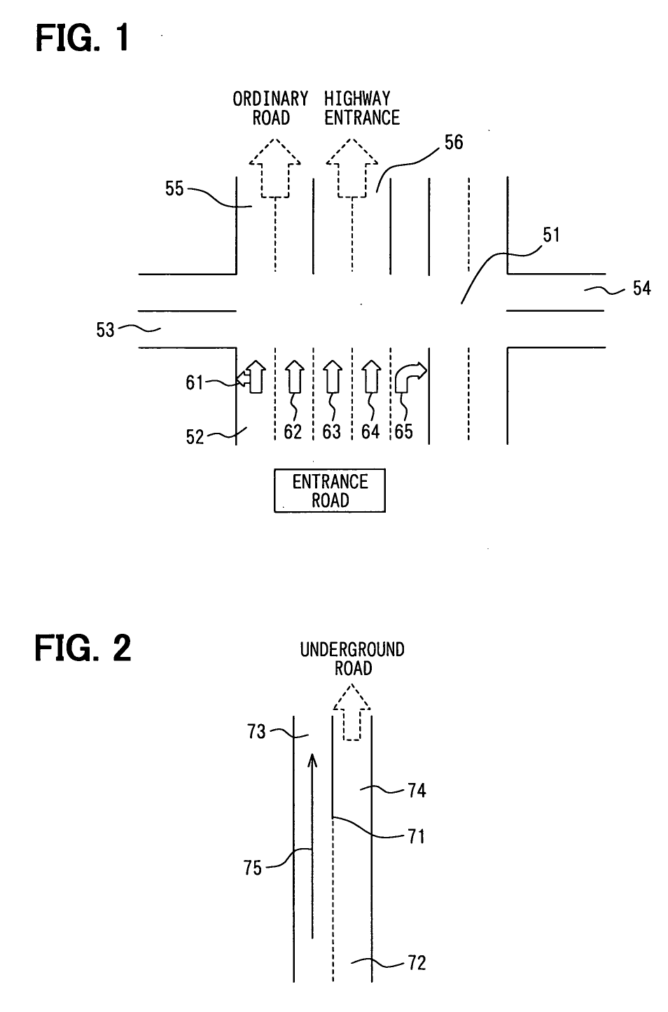

The controlling circuit 19 has a RAM, a ROM, and a CPU, which are not illustrated in FIG. 1. The CPU retrieves from the ROM and the external storage 18 and runs programs for the operation of the car navigation device 1. During the execution, it retrieves information from the ROM, the RAM, and the external storage 18, stores information on the RAM and the external storage 18, sends signals to the display 13 and the audio amplifier 14, and receives signals from the positioning device 11 and the operating switches 12.

Specifically, the CPU runs the programs to execute processes such as position determination, navigational route calculation, and route guidance.

By executing the position determination, the CPU specifies a current position and/or a current heading direction of an automobile which has the car navigation device 1 on board, based on the signals from the positioning device 11 by using techniques such as well-known map-matching algorithm.

By executing the navigational route calculation, the CPU accepts driver's designation of a destination by means of operating switches 12, and calculates the most suitable navigational route from the current position to the destination.

By executing the route guidance, the CPU retrieves the map data from the external storage 18 and outputs an image of a map with the navigational route and the current position laid on it. Furthermore, by executing the route guidance, the CPU composes image and voice data for guidance and stores them on the external storage 18 for every guidance intersection on the navigational route. The guidance intersections are intersections within the navigational route but are not intuitive intersections. The intuitive intersections are intersections through which the navigational route does pass intuitively following the roads' structure. For example, a intersection is a guidance intersection in many cases if the navigational route passes through the intersection turning left or right.

Moreover, by executing the route guidance of this embodiment, the CPU makes a decision as to whether to execute lane guidance or not for each of intersections on the navigational route that are not the guidance intersection (hereafter non-guidance intersection). Additionally, the CPU composes image and voice data for the lane guidance and stores them on the external storage 18 for every non-guidance intersection for which the lane guidance is to be executed. Such a non-guidance intersection will be referred as a lane guidance intersection hereafter.

Moreover, by executing the route guidance, when the automobile approaches a guidance intersection or a lane guidance intersection, the CPU outputs audio data that are based on the voice data for the guidance or the lane guidance to the audio amplifier 14, and outputs image data that are based on the image data for the guidance or the lane guidance to the display 13.

Hereafter, lane guidance decision and composing part of the route guidance will be described, in which the CPU makes a decision as to whether to execute the lane guidance or not for each non-guidance intersection and composes data for the lane guidance. To carry the part out, the CPU of the controlling circuit 19 runs a program 100 once for every intersections in the navigational route.

In running the program 100, the CPU firstly selects an intersection along the navigational route at step 110. The intersection is called as a selected route hereafter.

Next, at step 120, the CPU decides whether the selected intersection is a non-guidance intersection or not. If it is, then the CPU runs step 130 and if it is not, then the CPU terminates running the program 100.

At step 130, the CPU decides whether there is a lane restriction sign just back from the selected intersection. Specifically, if the LXD data that correspond to the road that proceeds into the selected intersection 18 along the navigational route have void data, then the CPU concludes that there is no lane restriction sign just back from the selected intersection and runs step 160. If the LXD data have non-void data (i.e. valid data), then the CPU concludes that there is a lane restriction sign just back from the selected intersection and runs step 140.

For example, in FIG. 1, the navigational route has the road 52 that proceeds into the intersection 51. Therefore, if the intersection 51 is the selected intersection, then the CPU will conclude that there is a lane restriction sign just back from the selected intersection. In FIG. 2, if the bifurcation 71 is the selected intersection, then the CPU will conclude that there is no lane restriction sign just back from the selected intersection.

Hereafter, a road that proceeds into the selected intersection along the navigational route is called an entrance road. Additionally, a lane that an entrance road has and that proceeds into the selected intersection is called an entrance lane. Additionally, a road that leaves the selected intersection along the navigational route is called an exit road.

At step 140, the CPU decides whether there is a plurality of entrance lanes that permit to exit the selected intersection along a road that heads roughly the same direction as the exit road does. Hereafter, such an entrance lane is called as an A-entrance lane. This decision was made based on the information of the configurations in the map data regarding the entrance road and the exit road and the LXD data that correspond to the entrance road.

To decide whether an entrance lane is an A-entrance lane, the CPU calculates a direction from the entrance road into the selected intersection as an entrance direction, calculates a direction from the selected intersection to the exit road as an exit direction, and calculates a relative direction of the exit direction against the entrance direction. Moreover, the CPU calculates a direction along which the entrance lane permits to exit the selected intersection as a permitted direction. The permitted direction is shown in the direction flag of the corresponding entry line. Then if the angle between the relative direction and the permitted direction is the same or below a preset reference angle, then the CPU concludes the entrance lane is an A-entrance lane.

The preset reference angle is preferably 22.5 degrees, but not restricted to the value. The preset reference angle can be any angle such as 10 degrees, 30 degrees, and 50 degrees. Besides, the reference angle can vary from an intersection to another. For example, the reference angle can be determined depending on the number and the widths of lanes in the entrance road.

For example, in FIG. 1, because the relative direction of the ordinary road 55 against the entrance road 52 is almost straight and forward direction, the entrance lanes corresponding to the signs 62-64 that permit to exit straight ahead are A-entrance lanes. Additionally, the entrance lane corresponding to the sign 65 that only permits to turn right is not an A-entrance lane.

As is typical in an entrance lane which permits both to turn left and to go straight ahead, there are entrance lanes with their direction flags having a plurality of ON bits that correspond to different directions. Such an entrance lane is an A-entrance lane if the angle between the relative direction and a permitted direction regarding one of the directions is the same or below the reference angle.

Therefore, in FIG. 1, because the entrance lane corresponding to the sign 61 only permits both to go straight ahead and to turn left, it is an A-entrance lane.

Hereafter, a permitted direction is called a decided direction if it meets the relative direction at an angle that is the same or below the reference angle. In FIG. 1 the straight-ahead direction is a decided direction.

If the CPU decides there is a plurality of A-entrance lanes, then it runs step 150, and if it decides there is one or less A-entrance lane, then it terminates running the program 100.

At step 150, the CPU decides whether there is a plurality of roads along which the automobile can go when it enters the selected intersection from one of the A-entrance lanes found at step 140 and exits the intersection roughly along the decided direction. Hereafter, such a roads is called an A-road. The decision can be regarded as deciding whether there is an A-road other than the exit road. If the angle between the decided direction and the relative direction of the road in question against the entrance road is the same or below a preset reference angle, then the CPU concludes the road in question is an A-road.

The preset reference angle is preferably 22.5 degrees, but not restricted to the value. The preset reference angle can be any angle such as 10 degrees, 30 degrees, and 50 degrees. Besides, the reference angle can vary from one intersection to another intersection. For example, the reference angle can be determined depending on the number of the roads connected with the selected intersection and the widths of the entering road and the candidate of the A-road.

For example, in FIG. 1, the ordinary road 55 and the highway 56 are A-roads, which go roughly along the decided direction. If the CPU decides there is a plurality of A-roads, then it runs step 180, and if it decides there is one or no A-entrance lane, then it terminates running the program 100.

At step 160, the CPU decides whether the selected intersection is an acute bifurcation and the exit road of the acute bifurcation is a member of an acute pair of roads. The CPU decides that the selected intersection is an acute bifurcation if it is connected with two roads other than the entrance road and the linear distance between two points is the same as or shorter than a threshold R, wherein the two points are placed at distances L along the two roads beyond the selected intersection. The two roads pairs up as an acute pair if the above condition is satisfied. Thus, the acute pair consists of two roads other then the entering road which are connected with the bifurcation and leave the bifurcation to a direction within an acute angle. The threshold R is preferably 20 meters, but not restricted to the value.

The distances L is preferably 100 meters but not restricted to the value. The ratio of the threshold R to the distance L can be any other value than 0.2, such as 0.1, 0.3, 0.8, and 1.2. Besides, the threshold R can vary from one intersection to another intersection. For example, the reference angle can be determined depending on the number and the widths of the roads connected with the selected intersection.

For example, in FIG. 2 where the navigational route is represented by an arrow 75, the surface road 73 and the underground road 74 become an acute pair and the bifurcation 71 is an acute bifurcation.

If the CPU decides that the exit road of the selected intersection is a member of an acute pair, then it runs step 170, and if it does not, then it terminates running the program 100.

At step 170, the CPU decides whether the number of the entrance lanes into the selected intersection is the same as the total number of lanes that belong to the acute pair and proceed away from the selected intersection. In FIG. 2, the acute pair 73 and 74 has two lanes in total and the entrance road 72 has two lanes, therefore the CPU concludes that the two numbers are the same. If the CPU concludes the two numbers are the same, then it runs step 180, and if it does not, then it terminates running the program 100.

At step 180, as a process for lane guidance, the CPU determines the selected intersection to be a lane guidance intersection, composes image and voice data for the lane guidance, and stores them on the external storage 18.

In executing the lane guidance, the CPU indicates a entrance lane to take by voice or image. The lane to take is decided in the manner described in (A) and (B) below.

(A) In the Case where Step 180 is Run Following Step 150

The lane to take is decided based on a relative position of the exit road among the A-roads, the number of the lanes each A-road has, the number of the entrance lanes, and so on. For example, in FIG. 1, the navigational route goes from the entrance road 52 in FIG. 1 through the ordinary road 55, the exit road 55 is the leftmost road of the A-road 55 and 56, there are four A-entrance lanes 61-64, and the exit road 55 has two lanes. In this case, in the lane guidance the CPU indicates left two lanes 61 and 62, which are placed on the same side as the exit road 55 and are the same in number as the lanes in the exit road 55, and make a suggestion to proceed along the two lanes 61 and 62 into the selected intersection 51. At this occasion, the CPU may make a suggestion to proceed along the leftmost lane 61 into the selected intersection 51.

(B) In the Case where Step 180 is Run Following Step 170

The lane to take is decided based on whether the exit road is placed to the left or right to the other member of the acute pair, and on how many lanes the exit road has that go away from the selected intersection. For example, in FIG. 2, the arrow 75 in FIG. 2 shows the navigational route, the exit road 73 is the leftmost road of the acute pair 73 and 74, and the exit road 73 has a lane that goes away from the selected intersection 75. In this case, in the lane guidance the CPU indicates the single lane 75, which is placed on the same side as the exit road 73 and is the same in number as the lane in the exit road 73, and makes a suggestion to proceed along the lane 75 into the selected intersection 71.

After step 180 was run, the CPU terminates running the program 100.

During the execution of the route guidance, when the automobile approaches the lane guidance intersection, the CPU of the controlling circuit 19 initiates the lane guidance. The voice for the lane guidance which the CPU makes the speaker 15 output is, for example, “In a short time you go straight ahead. Drive your car along the lanes to the left.”. The CPU may also make the display 13 to show a magnified map or illustrations of the lane guidance intersection together with the voice.

Thus, while the CPU of the controlling circuit 19 is running the program 100 and others, the car navigation device 1 sequentially selects one of the guidance intersections within the navigational route to the destination (see step 110), and if the selected intersection is the non-guidance intersection (see step 120), then decides whether there are LXD data that show which direction is permitted to exit the non-guidance intersection along on entering it from each entrance lane in the entrance road (see step 130).

If the LXD data exist, then if there is a plurality of A-entrance lanes which permit to exit the intersection along roughly the same direction as the exit road goes (see step 140), and if there is a plurality of roads along which at least one of those A-entrance lanes is permitted to exit the intersection (see step 150), then the car navigation device 1 determines the selected intersection to be a lane guidance intersection and executes the process for the lane guidance at the intersection (see step 180).

Thus, the car navigation device 1 executes the lane guidance for an intersection if there is a plurality of entrance lanes that permit to exit the intersection along the exit roads of its navigational route, and if there is a plurality of roads along which the automobile is permitted to exit the intersection on entering it along one of the entrance lanes. Therefore, in a case where two roads head away from an intersection toward almost the same direction and one of the two roads is a navigational route, the car navigation device 1 can reduce the possibility than ever to let a driver drive his automobile into the wrong road despite its navigational route.

Besides, the decision at step 140 that there is a plurality of A-entrance lanes which permit to exit the intersection along roughly the same direction as the exit road goes can be regarded as the decision that there is a plurality of entrance lanes which have resemblance to each other in their exit directions from the selected intersection and that the exit directions are roughly the same as the direction from the selected intersection to the exit road. Additionally, the decision at step 150 that there is a plurality of roads along which at least one of those A-entrance lanes is permitted to exit the intersection can be regarded as the decision that those A-entrance lanes with resemblance in the exit directions are connected with different roads through the intersection.

Moreover, if the exit directions of the entrance lanes are roughly the same as the direction of the exit road, then it is highly likely that one of the roads the entrance lanes are connected with is the exit road. Based on the idea, the decision at step 140 that those A-entrance lanes with resemblance in the exit directions are connected with different roads through the selected intersection can be regarded as the decision that one of the roads the entrance lanes are connected with is the exit road.

Additionally, if the LXD data do not exist, then if the selected intersection is an acute bifurcation (see step 160) and if the number of the entrance lanes into the selected intersection is the same as the total number of lanes that belong to the acute pair (see step 170), then the car navigation device 1 determines the selected intersection to be a lane guidance intersection and executes the process for the lane guidance at the intersection (see step 180).

Thus, the car navigation device 1 executes the intensive guidance for driving the automobile, based on the decision that the total number of lanes that belong to the acute pair of roads at selected intersection which are decided to be an acute bifurcation is the same as the number of lanes of the entrance road into the selected intersection. Therefore, in a case two roads head away from an intersection toward almost the same direction and one of the two roads is a navigational route, the car navigation device 1 can reduce the possibility than ever to let a driver drive his automobile into the wrong road despite its navigational route.

Besides, the fact that the selected intersection is an acute bifurcation and there is a plurality of entrance lanes into the selected intersection can be regarded as the fact that there is a plurality of entrance lanes which have resemblance to each other in their exit directions from the selected intersection.

Moreover, if the number of the entrance lanes into the selected intersection is the same as the total number of lanes that belong to the acute pair, it is highly likely that the entrance lanes are connected with the members of the acute pair on one to one basis. Based on the idea, the fact that number of the entrance lanes into the selected intersection is the same as the total number of lanes that belong to the acute pair can be regarded as the fact that those entrance lanes are connected with the different exit roads. Additionally, the fact that the exit road belongs to the acute pair can be regarded as the fact that one of the roads the entrance lanes are connected with is the exit road.

The present invention should not be limited to the embodiment discussed above and shown in the figures, but may be implemented in various ways without departing from the spirit of the invention.

For example, in the embodiment, at step 130 and 140 of the program 100, the CPU decides the selected intersection to be a lane guiding intersection based on the LXD data and the information on the directions of the roads connected with the intersection such as the exit road.

However, the car navigation device 1 may store lane-exiting road correspondence data (hereafter LEC data) for use in a case that the automobile enters an intersection from a road and exit the intersection along another road connected with it. Specifically, the LEC data show correspondence of a lane to roads along which the automobile is permitted to exit the intersection on entering it from the lane. The car navigation device 1 may execute a process as a substitute for step 140 and step 150 using the LEC data. Specifically, when the selected intersection is a non-guidance intersection, the CPU may;

(1) specify entrance lanes which permit to exit the intersection along the exit road, based on the LEC data for the entrance road into the intersection,

(2) decide whether the entrance road has another entrance lane (hereafter the second entrance lane) which meets conditions that according to the LXD data for the entrance road the both direction flags of the second entrance lane and the specified entrance lane has vale ON regarding the same directions and that according to the LEC data the second entrance lane prohibit from exiting the intersection along the exit road, and;

(3) if it has, then run step 180.

In this case, the fact that the entrance road has another entrance lane which meets the conditions that according to the LXD data for the entrance road the both direction flags of the second entrance lane and the specified entrance lane has vale ON regarding the same directions can be regarded as the fact that there is a plurality of entrance lanes which have resemblance to each other in their exit directions from the selected intersection, that the exit directions are roughly the same as the direction from the selected intersection to the exit road, and that one of the roads the entrance lanes are connected with is the exit road. Additionally, the fact that the automobile is prohibited from exiting the intersection along the exit road on entering the second entrance lane can be regarded as the fact that those entrance lanes are connected with different roads through the intersection.

Thus, the car navigation device 1 comes within the scope of the present invention if it makes a decision and based on the decision makes intensive guidance for the selected intersection, wherein the decision is that the entrance road into the selected intersection has a plurality of lanes which has resemblance to each other in their exit directions and are connected with different roads through the intersection, and that one of the roads are the exiting road along the navigational route, and based on the decision makes intensive guidance for the selected intersection.

Additionally, in the embodiments, at step 180 of the program 100 the car navigation device 1 executes the process for the direction guidance and the lane guidance. However, it may execute exiting road guidance as well as the direction guidance and the lane guidance. For example it may output the voice saying, “In a short time you go straight ahead” “Drive your car along the lanes to the left and go along the ordinary road.”

The car navigation device 1 may also execute the exiting road guidance and the direction guidance. For example it may output the voice saying, “In a short time you go straight ahead” “Drive your car and exit along the ordinary road.” Thus, even without the lane guidance, the exiting road guidance for the driver reduces the possibility to let the driver go into the wrong road despite the navigational route.

The car navigation device 1 may also execute only the direction guidance. For example it may output the voice saying, “In a short time you go straight ahead.”. Thus, even without the lane guidance or the exiting road guidance, more intensive guidance than usual such as voice guidance or intersection map magnification can draw driver's special attention to the intersection. Therefore, even if it is unclear which lane to take just with the information from the car navigation device 1, the information can reduce the possibility to let the driver go into the wrong road despite the navigational route. Thus, at step 180, the process for the intensive guidance for the selected intersection will suffice.

Additionally, in the embodiments, the car navigation device 1 executes process for the intensive guidance for the selected intersection when it decides at step 170 that the number of the entrance lanes is the same as the number of the lanes the acute pair has. However, the car navigation device 1 may execute process for the intensive guidance when it decides at step 170 that there is a plurality of entrance lanes.

Additionally, the LXD data which the external storage 18 stores may be made independently of lane restriction signs such as signs painted on roads

Additionally, at step 160, the CPU may decide the selected intersection is an acute bifurcation if it is connected with two roads other than the entrance road and the linear distance between two points is the same as or shorter than a threshold R (ex. 20 m), wherein the two points are placed at distances L (ex. 100 m) along the two roads beyond the selected intersection. The two roads pairs up as an acute pair if the above condition is satisfied. Thus, the acute pair consists of two roads other then the entering road which are connected with the bifurcation and leave the bifurcation to a direction within an acute angle.

What is claimed is:

1. A navigation device comprising:
a selection means for selecting an intersection within a navigational route to a destination;
a decision means for deciding that an entrance road into the selected intersection has a plurality of entrance lanes which meet the following conditions:
(1) the entrance lanes have resemblance to each other in their exit directions from the selected intersection;
(2) the entrance lanes are connected with different roads through the selected intersection; and
(3) one of the roads is an exit road which leaves the selected intersection along the navigational route; and
an execution means for executing a process for intensive guidance regarding the selected intersection based on the decision of the decision means.

2. The navigation device according to claim 1, wherein:
the decision means includes:
a lane-plurality decision means for making a decision that the entrance road has the plurality of entrance lanes which permit to exit the selected intersection along roughly the same direction as the exit road proceeds; and
a road-plurality decision means for making a decision that there is a plurality of roads connected with one of the entrance lanes through the selected intersection; and
the execution means executes the process based on the decisions of the lane-plurality decision means and the road-plurality decision means.

3. The navigation device according to claim 2, further comprising a storage medium storing lane-classified exit direction data showing a permitted direction to exit the intersection on entering the intersection from each lane in the entrance road, wherein the lane-plurality decision means makes the decision thereof based on the lane-classified exit direction data.

4. The navigation device according to claim 1, wherein:
the decision means includes:
a multilane decision means for making a decision that the entrance road into the selected intersection has a plurality of entrance lanes; and
a bifurcation decision means for making a decision that the selected intersection is an acute bifurcation; and
the execution means executes the process based on the decisions of the multilane decision means and the bifurcation decision means.

5. The navigation device according to claim 4, wherein the multilane decision means makes a decision that an acute pair of roads has as many lanes in total as the entrance road into the selected intersection has, wherein the acute pair consists of two roads other than the entering road and is connected with the bifurcation and leave the bifurcation to a direction within an acute angle.

6. The navigation device according to claim 1, wherein the execution means executes a process for at least one of lane guidance and guidance specifying the exit road regarding the selected intersection.

7. A method for route guidance comprising:
a selection step for selecting an intersection within a navigational route to a destination;
a decision step for deciding that an entrance road into the selected intersection has a plurality of entrance lanes which meet the following conditions:
(1) the entrance lanes have resemblance to each other in their exit directions from the selected intersection;
(2) the entrance lanes are connected with different roads through the selected intersection; and
(3) one of the roads is an exit road which leaves the selected intersection along the navigational route; and
an execution step for executing a process for intensive guidance regarding the selected intersection based on the decision of the decision step.

8. A computer program product for route guidance, comprising:
at least one computer-readable medium; and
a computer program mechanism embedded in the medium for causing a computer to:
select an intersection within a navigational route to a destination;
decide that an entrance road into the selected intersection has a plurality of entrance lanes which meet the following conditions:
(1) the entrance lanes have resemblance to each other in their exit directions from the selected intersection;
(2) the entrance lanes are connected with different roads through the selected intersection; and
(3) one of the roads is an exit road which leaves the selected intersection along the navigational route; and
execute a process for intensive guidance regarding the selected intersection based on the decision.

9. A computer program product for route guidance, comprising:
at least one computer-readable medium; and
a computer program mechanism embedded in the medium for causing a computer to:
make a decision that the entrance road has a plurality of entrance lanes which permit to exit the selected intersection along roughly the same direction as the exit road proceeds; and
make a decision that there is a plurality of roads connected with one of the entrance lanes through the selected intersection; and
execute a process for intensive guidance regarding the selected intersection based on both of the decisions.

10. A computer program product for route guidance, comprising:
at least one computer-readable medium; and
a computer program mechanism embedded in the medium for causing a computer to:
make a decision that the entrance road into the selected intersection has a plurality of entrance lanes; and
make a decision that the selected intersection is an acute bifurcation; and
execute a process for intensive guidance regarding the selected intersection based on both of the decisions.

11. A navigation device comprising:
a control circuit for:
selecting an intersection within a navigational route to a destination; and
deciding that an entrance road into the selected intersection has a plurality of entrance lanes which meet the following conditions:
(1) the entrance lanes have resemblance to each other in their exit directions from the selected intersection;
(2) the entrance lanes are connected with different roads through the selected intersection; and
(3) one of the roads is an exit road which leaves the selected intersection along the navigational route; and
a user interface for making intensive guidance regarding the selected intersection based on the decision of the control circuit.
